(19) United States
(12) Patent Application Publication
(10) Pub. No.: US 2007/0186483 A1
(43) Pub. Date: Aug. 16, 2007

(54) Composite abrasive compact

(76) Inventors: Klaus Tank, Johannesburg (ZA); Cornelis Roelof Jonker, District Pretoria (ZA)

Correspondence Address: Leopold Presser, Esq.;Scully, Scott, Murphy & Presser, 400 Garden City Plaza, Garden City, NY, 11530, US

(21) Appl. No.: 11/712,067

(22) Filed: Feb. 28, 2007

Related U.S. Application Data
(63) Continuation of application No. 10/503,323, filed on Jun. 6, 2005, now abandoned.

(30) Foreign Application Priority Data
Jan. 30, 2002 (ZA) 2002/0826

(51) Int. Cl. B23F 21/03; B24B 7/16; B23F 21/23; B24B 33/00; B24B 5/00; B24B 7/00; B24D 11/00; B24D 3/02

(52) U.S. Cl. 51/297; 451/540; 51/307; 51/308; 51/309

(57) ABSTRACT

A composite abrasive compact comprises an abrasive compact layer, generally a diamond abrasive compact layer, bonded to a substrate. The abrasive compact layer is characterized by: (i) an inner region, in contact with a surface of the substrate, (ii) a first intermediate region in contact with the inner region, (iii) a second intermediate region in contact with the first intermediate region, (iv) an outer region in contact with the second intermediate region and containing ultra-hard abrasive particles having at least three different average particle sizes, and (v) the composition in the inner region, and first and second intermediate regions varying in composition such that there is a gradulated change in thermal expansion of the abrasive compact layer between the substrate and the outer region.

### BACKGROUND OF THE INVENTION

The present invention relates to a composite abrasive compact.

Abrasive compacts are used extensively in cutting, milling, grinding, drilling, boring and other abrasive operations. Abrasive compacts comprise a mass of abrasive particles, often diamond or cubic boron nitride particles, bonded into a coherent polycrystalline conglomerate. The content of abrasive particles in the compact is high, and there is generally an extensive amount of direct bonding of abrasive particles one to another, particularly in the case of diamond compacts. Abrasive compacts containing diamond or cubic boron nitride are generally made under conditions of elevated pressure and elevated temperature (HPHT conditions) at which the abrasive particles are thermodynamically stable.

Diamond abrasive compacts are also referred to as polycrystalline diamond, PCD or PDC. Cubic boron nitride compacts are also known as polycrystalline cBN or PcBN.

Abrasive compacts tend to be brittle and in use such compacts are frequently bonded to a cemented carbide substrate to afford support. Such supported abrasive compacts are known in the art as composite abrasive compacts. Composite abrasive compacts may be used as such in a working surface of an abrasive tool.

Abrasive compacts bonded to a cemented carbide substrate made at HPHT conditions are brought into or close to an equilibrium state at those conditions. Bringing the compacts to conditions of normal temperature and normal pressure induces large stresses in the abrasive compact due to the different thermal and mechanical/elastic properties of the abrasive layer and the substrate. The combined effect is to place the abrasive layer in a highly stressed state. Finite element analysis shows that the abrasive layer may be in tension in some regions whilst being in compression elsewhere. The nature of the stresses is a complex interaction of the conditions of manufacture, the nature of the materials of the abrasive layer and the substrate, and the nature of the interface between the abrasive layer and the substrate, amongst others. In service, such a stressed abrasive compact is predisposed to premature failure by spalling, delamination and other mechanisms. That is to say, the abrasive compact fails prematurely due to separation and loss of all or part of the abrasive layer from the cutting surface of the abrasive compact, and the higher the residual stresses, the greater is the probability of premature failure.

This problem is well recognized in the industry and there have been a number of techniques applied in an attempt to solve it.

Various abrasive compact structures have been proposed in which the interface between the abrasive layer and the supporting substrate contains a number of ridges, grooves, indentations or asperities of one type or another aimed at reducing the susceptibility of the said interface to mechanical and thermal stresses. Such structures are taught, for example, in U.S. Pat. Nos. 4,784,203, 5,011,515, 5,486,137, 5,564,511, 5,906,246 and 6,148,937. In effect, these patents focus on distributing the residual stresses over the largest possible area.

U.S. Pat. No. 6,189,634 teaches that providing a hoop of polycrystalline diamond extending around the periphery of the abrasive compact in addition to the normal polycrystalline layer on the substrate surface reduces residual stresses in the compact. The combination of a peripheral hoop of polycrystalline diamond and a non-planar, profiled interface is taught in U.S. Pat. No. 6,149,695. In this case, the projections into the substrate and into the polycrystalline diamond layer are claimed substantially to balance and modify the residual stresses allowing the abrasive compact to withstand greater imposed loads and cutting forces. U.S. Pat. No. 6,189,634 teaches, amongst its numerous embodiments, a similar stress reduction method.

Extending one or more protrusions from the substrate through the abrasive layer to present an area of substrate on the working surface of the composite abrasive compact is another solution to the problem offered by U.S. Pat. Nos, 5,370,717, 5,875,862 and 6,189,634.

Another method applied to solving the problem of a highly stressed composite abrasive compact is to provide one or more interlayers of a different material with properties, particularly thermal and mechanical/elastic properties, intermediate between the properties of the substrate and the abrasive layer. The purpose of such interlayers is to accommodate some of the stresses in the interlayers and thereby reduce the residual stresses in the abrasive layer. This method is exemplified by U.S. Pat. No. 5,510,913 which provides for an interlayer of sintered polycrystalline cubic boron nitride. Another example is U.S. Pat. No. 5,037,704 which allows the interlayer to comprise cubic boron nitride with aluminium or silicon and at least one other component selected from the group comprising the carbides, nitrides and carbonitrides of the elements of Groups 4A, 5A and 6A of the Periodic Table of the Elements. A further example, U.S. Pat. No. 4,959,929, teaches that the interlayer may comprise 40% to 60% by volume cubic boron nitride together with tungsten carbide and cobalt.

In yet another approach, U.S. Pat. No. 5,469,927 teaches that the combination of a non-planar interface and transition layers may be used. In particular, this patent describes the use of a transition layer of milled polycrystalline diamond with tungsten carbide in the form of both particles of tungsten carbide alone and pre-cemented tungsten carbide particles. Furthermore, there is provision for tungsten metal to be mixed into the transition layer to enable excess metal to react to form tungsten carbide in situ.

There is always a need to improve the durability and robustness of composite abrasive compacts, especially those compacts fitted to drills for down-hole applications, i.e. roller cone and percussion drills, where down-time has major cost implications.

### SUMMARY OF THE INVENTION

According to the present invention, a composite abrasive compact comprises an abrasive compact layer bonded to a substrate, generally a cemented carbide substrate, the abrasive compact layer being characterised by:
(i) an inner region, in contact with a surface of the substrate,
(ii) a first intermediate region in contact with the Inner region,
(iii) a second intermediate region in contact with the first intermediate region, and
(iv) an outer region in contact with the second intermediate region and containing ultra-hard abrasive particles having at least three different average particle sizes.

The inner region and first and second intermediate regions vary in composition to create a graduated change in properties from the substrate to the outer region. The outer region provides the composite abrasive compact with a working surface.

Essential to the invention is the provision of three regions or layers between the substrate and outer region, which vary in composition such that a graduated change in thermal expansion of the abrasive compact layer is achieved between the substrate and the outer region. This graduated change in thermal expansion will preferably be achieved by providing each of the three regions with a mixture of the ultra-hard abrasive particle present in the outer region and one or more refractory particles, the mixtures of regions differing from each other. For example, the mixture of inner region may contain less ultra-hard abrasive particles than the mixture of the first intermediate region which itself may contain less ultra-hard abrasive particles than the mixture of the second intermediate region.

Also essential to the invention is that the outer region in contact with the second intermediate region contains ultra-hard abrasive particles having at least three different average particle sizes. Such a region, it has been found, provides an abrasive compact with particularly effective impact resistance and hardness properties.

The surface of the substrate in contact with the abrasive compact layer may be planar or non-planar, including profiled surfaces. A non-planar surface minimises the mechanical/elastic stresses created as a result of the high pressure/high temperature (HPHT) sintering procedure followed to produce the composite abrasive compact.

The various regions of the abrasive compact layer will generally take the form of layers. The interfaces between these layers will generally not be parallel or concentric.

The invention has particular application to composite abrasive compacts which may be used as tool inserts in drill bits such as roller cone and percussive drill bits, wherein the interface between the abrasive compact layer and the substrate is convex and the working surface of the outer region is also convex. When the substrate is cylindrical, the shape of the composite abrasive compact is thus of a bullet shape. The interfaces between the various regions will also preferably be convex.

### BRIEF DESCRIPTION OF THE DRAWINGS

FIG. 1 is a sectional view of an embodiment of a composite abrasive compact of the method of the invention; and

FIGS. 2a to 2f are enlargements of the area circled in FIG. 1 and represent six separate embodiments.

### DESCRIPTION OF EMBODIMENTS

The ultra-hard abrasive particles may be diamond or cubic boron nitride, but are preferably diamond particles.

The substrate is preferably a cemented carbide substrate such as cemented tungsten carbide, cemented tantalum carbide, cemented titanium carbide, cemented molybdenum carbide or a mixture thereof. The cemented carbide substrate may contain particles of a grain inhibiting agent such titanium carbide, tantalum carbide, vanadium carbide or a mixture thereof. The binder metal for such cemented carbide may be any known in the art such as nickel, cobalt, iron or an alloy containing one or more of these metals. Typically the binder will be present in an amount of 6 to 20% by mass. Some of the binder metal may infiltrate the abrasive compact during the HPHT treatment. A shim or layer of binder may be used for this purpose.

To improve the service life of a composite abrasive compact, it is necessary to reduce the residual stresses induced in the compact as a result of the HPHT treatment. The residual stresses due to the thermal expansion differences between the abrasive layer and the substrate are minimised in the invention by providing a graduated change in thermal expansion from the substrate to the outer or working region of the abrasive compact layer.

More particularly, in the present invention, this is achieved by the introduction of a number of intermediate regions or layers between the outer abrasive region or layer and the substrate, each region or layer having a thermal expansion such that there is a graduated change in thermal expansion from the outer region or layer to the substrate. The control of thermal expansion may be achieved by admixing one or more types of refractory particles of low thermal expansion with ultra-hard abrasive particles, and adjusting the relative proportions of ultra-hard abrasive particles and refractory particles to achieve the desired thermal expansion. A metal or alloy may be present in each or some of the regions. When such a metal or alloy is present, the amount relative to the amount of ultra-hard abrasive particle and refractory particle may be adjusted to achieve the desired graduated thermal expansion. Examples of suitable refractory particles with low thermal expansion are carbides, oxides and nitrides of silicon, hafnium, titanium, zirconium, vanadium and niobium, an oxide and nitride of aluminium, cubic boron nitride, and carbides of tungsten, tantalum and molybdenum. Tungsten carbide is a particularly suitable refractory particle. Examples of suitable metals and alloys are nickel, cobalt, iron or an alloy containing one or more of these metals. Preferably, the metal or alloy is the same as the metal or alloy present in the cemented carbide substrate.

The composite abrasive compact of the invention is characterised by the use of three different regions interposed between the substrate and the outer abrasive compact region which provides a working surface for the compact. Each region may be discernible in the sintered compact under suitable magnification. The boundary between each discernible region may be regular or irregular.

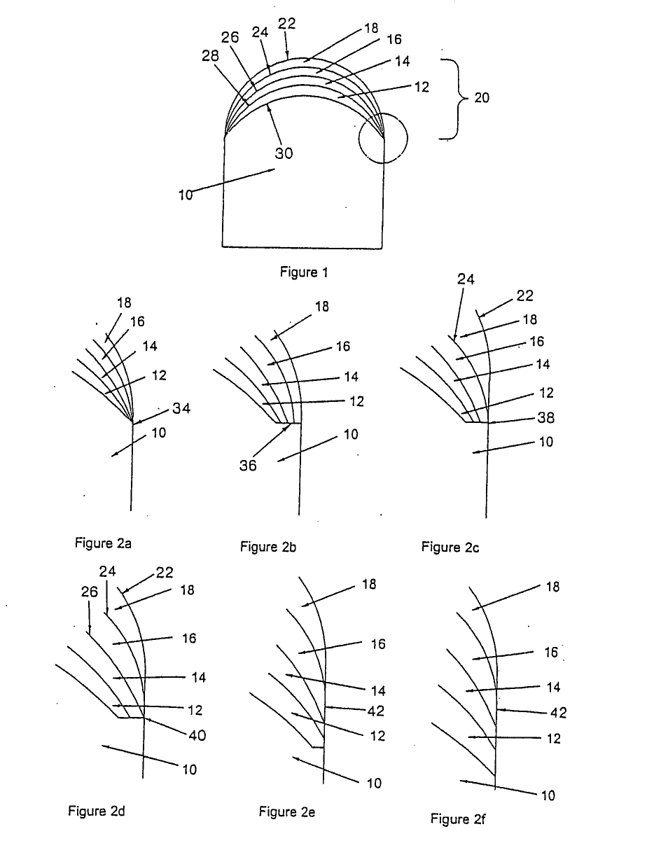

Embodiments of the invention will now be described with reference to the accompanying drawings. Referring first to FIG. 1, a composite abrasive compact comprises an abrasive compact layer 20 bonded to a substrate, generally a cemented carbide substrate, 10. The abrasive compact layer 20 comprises an inner region 12, a first intermediate region 14, a second intermediate region 16 and an outer region 18. The composite abrasive compact is of a bullet shape.

The outer surface 22 of the region 18 provides a working surface for the composite abrasive compact.

The interfaces 24, 26 and 28 between successive regions are all convex in shape. Similarly, the interface 30 between the region 12 and the substrate 10 is convex.

FIGS. 2a to 2f illustrate six different embodiments in which the regions of the abrasive compact layer 20 of FIG. 1 meet or intercept the substrate.

FIG. 2a illustrates an embodiment in which the regions of the abrasive compact layer 20 converge to a point 34

FIG. 2b illustrates an embodiment in which the regions of the abrasive compact layer 20 terminate on a ledge or plane 36.

FIG. 2c illustrates an embodiment similar to that of FIG. 2b save that the interface 22 and the interface 24 converge at a peripheral point 38.

FIG. 2d illustrates an embodiment similar to that of FIG. 2c save that the interface 26 also terminates at a peripheral point 40.

In the FIG. 2e embodiment, the regions 18, 16 and 14 all terminate at the periphery 42 of the insert while in the FIG. 2f embodiment, all of the regions of the abrasive compact layer 20 terminate at the periphery 42 of the insert.

In the composite abrasive compacts of the invention, the inner region (12 in the illustrated embodiments) may comprise a mixture of ultra-hard abrasive particles and refractory particles, and optionally a quantity of binder metal. The proportion of ultra-hard abrasive particles is generally in the range 20 to 30 volume per cent of the region and the proportion of refractory particles is generally in the range 80 to 70 volume per cent of the region. The metal binder, when used, is generally present in the amount of about 8 to 12 volume per cent of the total volume of the particles. Preferably, the proportion of ultra-hard particles is about 25 volume per cent, the proportion of refractory particles is about 75 volume per cent, and the metal binder about 10 volume per cent.

The first intermediate region (14 in the illustrated embodiments) may comprise a mixture of ultra-hard abrasive particles and refractory particles, and optionally a quantity of binder metal. The proportion of ultra-hard abrasive particles is generally in the range 45 to 55 volume per cent of the region and the proportion of refractory particles is generally in the range 55 to 45 volume per cent of the region. The metal binder, when used, is generally present in the amount of about 5 to 12 volume per cent of the total volume of the particles. Preferably, the proportion of ultra-hard particles is about 50 volume per cent, the proportion of refractory particles is about 50 volume per cent, and the metal binder about 7 volume per cent.

The second intermediate region (16 in the illustrated embodiments) may comprise a mixture of ultra-hard abrasive particles and refractory particles, and optionally a quantity of binder metal. The proportion of ultra-hard abrasive particles is generally in the range 70 to 80 volume per cent of the region and the proportion of refractory particles is generally in the range 30 to 20 volume per cent of the region. The metal binder, when used, is generally present in the amount of about 3 to 7 volume per cent of total volume of the particles. Preferably, the proportion of ultra-hard particles is about 75 volume per cent, the proportion of refractory particles is about 25 volume per cent, and the metal binder about 5 volume per cent.

In the inner region and the first and second intermediate regions the ultra-hard abrasive particles are generally in the particle size range 5 to 100 microns, and preferably in the size range 15 to 30 microns.

The outer region (18 in the illustrated embodiments) may comprise ultra-hard abrasive particles and metal binder. The ultra-hard particles are characterized by containing at least three, and preferably four, different particle sizes. The proportion of metal binder is about 2 per cent of the volume of ultra-hard abrasive particles. In the case of a mixture comprising three particle sizes, an example of the composition by average particle size is:

| Average particle size | Percent by mass |
|---|---|
| greater than 10 microns | at least 20 |
| between 5 and 10 microns | at least 15 |
| less than 5 microns | at least 15 |

The term “average particle size” as used above and hereinafter means that a major amount of the particles by mass will be close to the specified size although there will be some particles larger and some particles smaller than the specified size. Thus, for example, if the average particle size is stated as 10 microns, there will be some particles that are larger and some particles that are smaller than 10 microns, but the major amount of the particles will be at approximately 10 microns in size and a peak in the size distribution by mass of particles will be at 10 microns.

The term “percent by mass” as used above and hereinafter means that the percentages are the percentages by mass of the entire abrasive particle mass.

A specific particle size composition containing three particle sizes which is useful for the outer region is:

| Average particle size | Percent by mass |
|---|---|
| 12 microns | 25 |
| 8 microns | 25 |
| 4 microns | 50 |

In the case of a mixture comprising four diamond particle sizes, an example of the composition by average particle size is:

| Average particle size | Percent by mass |
|---|---|
| 25 to 50 microns | 25 to 70 |
| 15 to 24 microns | 15 to 30 |
| 8 to 14 microns | 5 to 45 |
| less than 8 microns | minimum 5 |

A specific particle size composition containing four particle sizes which is useful for the outer region is:

| Average particle size | Percent by mass |
|---|---|
| 30 microns | 65 |
| 22 microns | 20 |
| 12 microns | 10 |
| 4 microns | 5 |

A specific composition containing five particle sizes which is useful for the outer region is:

| Average particle size | Percent by mass |
|---|---|
| 22 microns | 28 |
| 12 microns | 44 |
| 6 microns | 7 |
| 4 microns | 16 |
| 2 microns | 5 |

In all regions, the binder metal powder, when present, will generally have a particle size of less than 10 microns, and preferably will be about 3 microns.

The composite abrasive compact of the invention may be made by providing a sintered substrate of the desired shape and a canister which fits on the outer surface of the substrate and has a closed end, the shape of which is complementary to the desired shape of the outer surface of the outer region. Mixtures are also provided to the desired composition of each of the regions. A temporary binder may be added to the mixtures to aid compaction and moulding. Each region may be shaped prior to being introduced to the canister, or may be shaped in situ in the canister. After the introduction of the regions in order in the canister, the substrate is fitted into the canister to complete a closure and form an assembly. In the case that a temporary binder is used, the temporary binder is removed by thermal decomposition or volatilisation. Examples of suitable temporary binders are starch, methyl cellulose, polymethyl methacrylate and camphor.

The assembly is placed in a conventional high pressure, high temperature apparatus and the assembly exposed to conditions of temperature and pressure necessary to produce an abrasive compact. The conditions of elevated pressure and elevated temperature are maintained for sufficient time for the abrasive layer to sinter and bond to the substrate. Generally, the HPHT conditions used are those at which the ultra-hard particles are thermodynamically stable. Such pressures are typically in the range 4 to 7 GPa and such temperatures are typically in the range 1200° C. to 1700° C.

After recovery from the high pressure, high temperature apparatus, the composite abrasive compact may be finished to the desired dimensions by any convenient means, such as centreless grinding.

In section, the regions 12, 14, 16, 18 of the abrasive layer 20 are distinguishable one from another by examination of the microstructure at appropriate magnification. The inner region 12 will generally consist of ultra-hard particles substantially isolated one from another or in small clusters. The isolated particles or small clusters are separated by refractory particles. There may be a proportion of intergrowth between adjacent refractory particles and between adjacent ultra-hard particles when present as small clusters. In the first intermediate region 14, there are generally approximately equal amounts by volume of ultra-hard particles and refractory particles. Both the ultra-hard particles and the refractory particles may appear as clusters of particles with a proportion of intergrowth between particles of like type. In the second intermediate region 16, the refractory particles are generally present as substantially isolated particles or as small clusters. The isolated particles or small clusters of refractory particles are separated one from another by ultra-hard particles which may be substantially intergrown. The regions are further characterised by a difference of metal binder content, when a metal binder is present, such that the inner region 12 contains more metal binder than the first intermediate region 14, which in turn contains more metal binder than the second intermediate layer 16.

The inner region, the first intermediate region and the second intermediate region have a thickness generally not less than 0.1 mm and generally not greater than 1 mm. Preferably, the thickness of these regions is in the range 0.1 mm to 0.6 mm.

The outer region has a thickness generally not less than 0.2 mm and generally not greater than 1 mm. Preferably, the thickness of the outer region is in the range 0.3 mm to 0.7 mm.

Comparative drop tests, in which a composite abrasive compact is fitted into a body and dropped on to a target, have shown that composite abrasive compacts of this invention have superior impact resistance to composite abrasive compacts made by prior art methods. Composite abrasive compacts of this invention withstand an impact dissipating 50 joules of energy, whereas prior art composite abrasive compacts withstand impacts dissipating about 35 joules of energy.

1. A composite abrasive compact comprising an abrasive compact layer bonded to a substrate, the abrasive compact layer being characterised by:
(i) an inner region, in contact with a surface of the substrate,
(ii) a first intermediate region in contact with the inner region,
(iii) a second intermediate region in contact with the first intermediate region,
(iv) an outer region in contact with the second intermediate region and containing ultra-hard abrasive particles having at least three different average particle sizes, and
(v) the composition in the inner region, and first and second intermediate regions varying in composition such that there is a graduated change in thermal expansion of the abrasive compact layer between the substrate and the outer region.

2. A composite abrasive compact according to claim 1 wherein the regions of the abrasive compact layer take the form of layers.

3. A composite abrasive compact according to claim 2 wherein the interfaces between the layers are not parallel or concentric.

4. A composite abrasive compact according to any one of the preceding claims wherein the interface between the abrasive compact layer and the substrate is convex and the working surface of the outer region is convex.

5. A composite abrasive compact according to any one of the preceding claims wherein the interfaces between the various regions are convex.

6. A composite abrasive compact according to any one of the preceding claims wherein the inner region and first and second intermediate regions each comprise a mixture of ultra-hard abrasive particle of the type present in the outer region and one or more refractory particles, the mixtures in the regions differing from each other.

7. A composite abrasive compact according to claim 6 wherein the mixture of the inner region contains less ultra-hard abrasive particles than the mixture of the first intermediate region which contains less ultra-hard abrasive particles than the mixture of the second intermediate region.

8. A composite abrasive compact according to claim 6 or claim 7 wherein the refractory particles are of low thermal expansion and are selected from carbides, oxides and nitrides of silicon, hafnium, titanium, zirconium, vanadium and niobium, an oxide and nitride of aluminium, cubic boron nitride and carbides of tungsten, tantalum and molybdenum.

9. A composite abrasive compact according to claims 6 to 8 wherein the mixture of the inner region comprises 20 to 30 volume percent of ultra-hard abrasive particle and 80 to 70 volume percent of refractory particle.

10. A composite abrasive compact according to claim 9 wherein the mixture of the inner region also contains a metal binder present in an amount of 8 to 10 volume percent of the total volume of the particles.

11. A composite abrasive compact according to any one claims 6 to 10 wherein the mixture of the first intermediate region comprises 55 to 45 volume percent of ultra-hard abrasive particle and 45 to 55 volume percent of refractory particle.

12. A composite abrasive compact according to claim 11 wherein the mixture of the first intermediate region also contains a metal binder present in an amount of 5 to 12 volume percent of the total volume of the particles.

13. A composite abrasive compact according to any one of claims 6 to 12 wherein a mixture of the second intermediate region comprises 70 to 80 volume percent of ultra-hard abrasive particle and 30 to 20 volume percent of refractory particle.

14. A composite abrasive compact according to claim 13 wherein the mixture of the second intermediate region also contains a metal binder present in an amount of 3 to 7 volume percent of the total volume of the particles.

15. A composite abrasive compact according to any one of the preceding claims wherein the ultra-hard abrasive particles in the outer region have a composition which is:

| Average particle size | Percent by mass |
|---|---|
| greater than 10 microns | at least 20 |
| between 5 and 10 microns | at least 15 |
| less than 5 microns | at least 15 |

16. A composite abrasive compact according to any one of claims 1 to 14 wherein the ultra-hard abrasive particles in the outer region have a composition which is:

| Average particle size | Percent by mass |
|---|---|
| 20 to 25 microns | 25 to 70 |
| 15 to 24 microns | 15 to 30 |
| 8 to 14 microns | 5 to 45 |
| less than 8 microns | minimum 5 |

17. A composite abrasive compact according to any one of the preceding claims wherein the substrate is a cemented carbide substrate.

18. A composite abrasive compact according to claim 1 substantially as herein described with reference to any one of FIGS. 1 to 2f of the accompanying drawings.
